(19) United States
(12) Patent Application Publication
(10) Pub. No.: US 2025/0086098 A1
(43) Pub. Date: Mar. 13, 2025

(54) AUTOMATIC ROLLBACK OF INJECTED FAULTS IN SYSTEM TESTING

(71) Applicant: Goldman Sachs & Co. LLC, New York, NY (US)

(72) Inventor: Bella Wiseman, Brooklyn, NY (US)

(21) Appl. No.: 18/828,856

(22) Filed: Sep. 9, 2024

Related U.S. Application Data
(60) Provisional application No. 63/537,361, filed on Sep. 8, 2023.

(51) Int. Cl. G06F 11/36

(52) U.S. Cl. CPC G06F 11/3688

(57) ABSTRACT

A fault injection system injects one or more faults into software or hardware components of a target system and automatically rolls back the injected faults upon incident creation at the target system. In one embodiment, modules of the fault injection system identify or receive one or more fault injection parameters for a target component, inject one or more faults into the target component according to the parameters, and monitor performance of the component and the target system to assess target system performance under adverse conditions. Responsive to detecting that an incident has been created at the target system, the fault injection system implements countermeasures to automatically roll back the injected faults and updates the incident to notify the target system of the fault injection testing.

### CROSS REFERENCE TO RELATED APPLICATIONS

This application claims the benefit of U.S. Provisional Application No. 63/537,361, filed Sep. 8, 2023, which is incorporated by reference in its entirety.

### BACKGROUND

### 1. Technical Field

The subject matter described relates generally to computer system testing and, in particular, to automatic rollback of injected faults upon incident creation.

### 2. Background Information

Chaos engineering is the discipline of deliberately injecting faults into a software or hardware system to discover its behavior under adverse conditions. Fault injection is in some cases performed without the explicit consent of the system owners. This may be advisable in a situation where the fault will definitely occur in n days and be irreversible at that time. Therefore, after notifying the system owners (who may or may not see the notification), a user introduces the fault early, together will a rollback mechanism, to mitigate the risk of the fault occurring later without the possibility of rollback.

In such a scenario, the system owner should be made aware of the outage so that they have knowledge of the upcoming irreversible fault and can fix the system such that it will be resilient to the fault when it occurs. But one also needs to ensure that the outage is automatically reversed as soon as the system owner is aware of it so that the impact of the outage is the minimum required to alert the system owner and no more.

Typically, faults are rolled back based on monitoring the system under test using predetermined SLIs (Service Level Indicators) against defined SLOs (Service Level Objectives). However, in a large organization, this may be difficult to do systematically. Different systems may use different monitoring tools. Additionally, some systems have monitoring that is overly noisy (many false alarms, which the owners have learned to ignore), or inadequate (an owner may not be aware of an outage until notified by a third-party, such as a customer).

### SUMMARY

The above and other problems are addressed by a computer system that automatically rolls back injected faults upon creation of an “incident” at the affected system. A fault identification module of a fault injection system receives or identifies one or more fault injection parameters for testing of a target software or hardware component at a target system. In various embodiments, the fault injection parameters include, for example, a fault type, a fault location (e.g., in a specified system, subsystem, or link between systems), a fault amplitude, whether the fault should be injected on demand or occur at a specified activation time or upon occurrence of an activation condition, a predicted impact on target component or system behavior, and the like. The fault injection system may perform testing in an operational system to test an active component under adverse conditions.

A fault injection module injects the one or more faults into the identified component of the target system according to the fault injection parameters and notifies a system monitoring module of the fault injection system, which tracks execution of the fault injection commands and, in some embodiments, performs data collection and analysis to assess the performance of the component under test and the target system. The system monitoring module also monitors the target system to detect the creation of an incident related to the one or more injected faults, e.g., via an application programming interface (API) that facilitates data exchange between the fault injection system and the target system. Responsive to detecting that an incident has been created, the fault injection module automatically implements one or more countermeasures to rollback the injected fault. In some embodiments, the system monitoring module notifies the target system of the fault injection and, optionally, an assessment of the effected target system components, allowing target system operators to identify and correct system defects or security vulnerabilities before anomalies occur without the possibility of rollback.

### BRIEF DESCRIPTION OF THE DRAWINGS

FIG. 1 is a block diagram of a networked computing environment suitable for providing automatic rollback of injected faults, according to one embodiment.

FIG. 2 is a block diagram illustrating one embodiment of the fault injection system of FIG. 1.

FIG. 3 is a flowchart illustrating a method for automatically rollback of injected faults in a target component, according to one embodiment.

FIG. 4 is a block diagram illustrating an example computer suitable for use in the networked computing environment of FIG. 1, according to one embodiment.

### DETAILED DESCRIPTION

Reference will now be made to several embodiments, examples of which are illustrated in the accompanying figures. Wherever practicable, similar or like reference numbers are used in the figures to indicate similar or like functionality. Where similar elements are identified by a reference number followed by a letter, a reference to the number alone in the description that follows may refer to all such elements, any one such element, or any combination of such elements. One skilled in the art will readily recognize from the following description that alternative embodiments of the structures and methods may be employed without departing from the principles described.

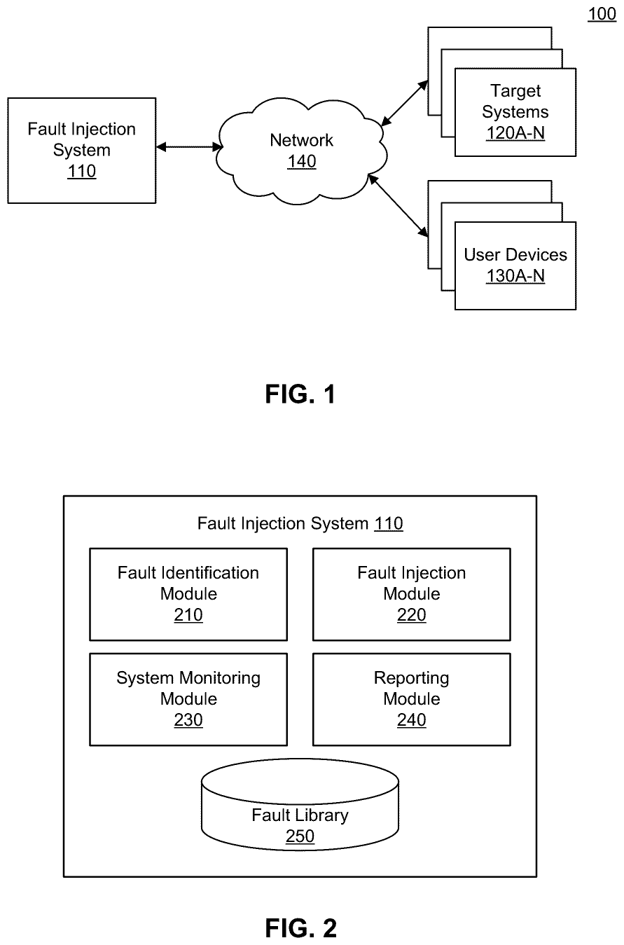

FIG. 1 illustrates one embodiment of a networked computing environment 100 suitable for providing automatic rollback of injected faults. In the embodiment shown in FIG. 1, the networked computing environment 100 includes a fault injection system 110, one or more target systems 120A-N, and one or more user devices 130A-N, all connected via a network 140. In other embodiments, the networked computing environment 100 contains different or additional elements. In addition, the functions may be distributed among the elements in a different manner than described. Moreover, while three target systems 120 are shown in FIG. 1 in order to simply and clarify the description, in other embodiments, the networked computing environment many include many target subsystems 120.

The fault injection system 110 is a network system configured to inject faults into software or hardware components of one or more target systems 120 and to automatically roll back the one or more injected faults upon creation of an incident at one or more of the impacted target systems 120. In one embodiment, the fault injection system 110 injects the faults in fully operational systems (i.e., after the component under test has been deployed). After injecting one or more faults into a component of a target system 120, the fault injection system 110 monitors the system 120 under test to determine when the target system 120 detects the presence of the fault(s) and implements one or more countermeasures to automatically roll back the injected fault(s) upon creation of an incident at the target system 120. In one example, the injected fault is a blocking control to the target system production environment (e.g., removal of log4j from all hosts by a specified date). The fault injection system rolls back the blocking control responsive to detecting that an incident has been created at the target system such that system operators who might otherwise be unaware of the system's dependency on log4j discover the dependency in a relatively safe manner and plan to remove it.

The modules and corresponding functionalities of the fault injection system 110 are described in more detail below with reference to FIG. 2. Moreover, while the embodiment of FIG. 1 illustrates the fault injection system 110 as a separate component of the networked computing environment 100 that interacts with the one or more target system 120 through the network 140, in other embodiments, the fault injection system 110 is a subsystem of the one or more target systems 120.

The target systems 120A-N are one or more systems having software or hardware components available for testing during normal operation of a deployed component. For example, a system operator may use the fault injection system 110 to subject an application to various types of faults at specified frequencies or during specified testing intervals. Injecting faults into an operational system might allow an operator to identify and resolve behaviors that may not occur in staging or prototype environments. Example software and hardware faults that may be injected include disconnecting a data center, powering down a machine, revoking an access key, unplugging a network cable, removing a software package from a package repository, and the like.

Each target system 120 has an incident creation and management process with which the target system 120 detects and logs anomalies, errors, and other deviations from expected behavior in its software and hardware components. These anomalies may cause a disruption to one or more components, impact internal or external users of the target system 120 (e.g., employees or customers), and require immediate response and resolution. Types of anomalies may vary significantly in terms of scope, duration, impact, and severity and may be detected in different ways, for example, via firewalls, antivirus software, intrusion detection and prevention systems that monitor system and network behavior, user reporting, etc.

Responsive to detecting the occurrence of an anomaly, the target system 120 creates an incident (also referred to as an incident log or an incident ticket) to document the anomaly and initial findings. Incident creation may be automatic or manual, and information included in the incident log may include one or more of an identification of an anomaly, an initial classification, an indication of infected system(s), timestamps, network logs, a source of the anomaly, an initial assessment of the impact on systems and internal and external users, response measures, previous incidents associated with the infected component or system, and the like. In one embodiment, an incident is automatically created at the target system 120 by running, on the target system, a probe configured to execute on the target system 120 at a specified interval to collect telemetry data describing operations of the target system 120. Responsive to the telemetry data failing one or more tests, the target system 120 automatically creates the incident.

The user device 130 is a computing device capable of receiving user input as well as transmitting to or receiving data from the fault injection system 110 via the network 120. For example, a user device 130 can be a desktop or a laptop computer, a smartphone, tablet, or another suitable device. Each user device 130 may have a screen for displaying content (e.g., documents, images, videos, or other content items) or receiving user input (e.g., a touchscreen). User devices 130 are configured to communicate via the network 140.

The network 140 may include any combination of local area and wide area networks employing wired or wireless communication links. In one embodiment, network 140 uses standard communications technologies and protocols. For example, network 140 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 140 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 140 may be represented using any format, such as hypertext markup language (HTML) or extensible markup language (XML). Some or all of the communication links of the network 140 may be encrypted.

FIG. 2 illustrates one embodiment of the fault injection system 110. In the embodiment shown, the fault injection system 110 includes a fault identification module 210, a fault injection module 220, a system monitoring module 230, a reporting module 240, and a fault library 250. In other embodiments, the fault injection system 110 has alternative configurations than shown in FIG. 2, including different, fewer, or additional components.

The fault identification module 210 determines fault injection parameters for one or more software or hardware components of a target system 120. Fault injection parameters include one or more target components for testing, one or more types of faults, fault amplitude, a fault activation time or condition, a fault location (e.g., in a specified system, subsystem, or function or in a link between systems), a predicted impact on system behavior, and the like. In one embodiment, the fault identification module 210 selects a fault for injection based on, for example, the type of component under test or the results of previous testing of the target component or other related components of the target system 120, the results of previous testing of similar components at other target systems 120 (which may be retrieved from the fault library 250), a predicted impact on the target system 120, whether the fault will affect internal or external users of the target system 120, a status of the target component, and the like. Alternatively, one or more of the fault injection parameters are specified by a user of the target system 120, e.g., via the user device 130. For example, a user may specify a specific software or hardware component for testing but not a testing interval or fault type or may select all of the fault injection parameters for a test.

Responsive to identifying or receiving fault injection parameters for the target component, the fault identification module 210 sends the parameters to the fault injection module 220 for implementation. The parameters are also be sent to the fault library 250 for storage in association with the one or more target component(s) under test and the target system 120. In one embodiment, where the target components are software programs, the fault injection module 220 uses one or more of the following software implemented fault injection (SWIFI) techniques to inject faults into components of the target system 120:

The fault injection module 210 uses a software trigger to inject a fault into the target component. Triggers may be time-based (e.g., when a timer reaches a specified time, an interrupt is generated and the interrupt handler associated injects the fault) or interrupt-based (hardware exceptions and software trap mechanisms are used to generate an interrupt at a specific location in the program code or on a particular event within the system, for instance, access to a specific memory location). The fault injection module 210 may use a number of different techniques to insert faults into a target system 120, including corruption of memory space (e.g., RAM, processor registers, or I/O map), system call interposition techniques (e.g., by intercepting operating system calls made by user-level software and injecting faults into them), and network-level fault injection (e.g., corruption, loss, or reordering of network packets at the network interface).

Still further, in some embodiments, the fault injection module 210 injects one or more faults into the target software component using commercial fault injection tools, such as Xception, beSTORM, Holodeck, Exhaustif, or the Mu Service Analyzer or research tools, such as Xception, Grid-FIT, MODIFI, Ferrari, FTAPE, DOCTOR, and the like.

In one embodiment, where the target components for testing comprise hardware elements of the target system 120, such as a central processing unit (CPU) or device memory, the fault injection module 120 uses one or more of the following hardware-implemented fault injection techniques:

Pin-level injection: The fault injection module 120 makes direct physical contact with circuit pins at the target component, producing voltage or current changes. Electrical currents and voltages at the pins may be altered using active probes (current added via probes attached to the pins) or via socket insertion (socket inserted between the target hardware component and its circuit board).

Injection without contact: The fault injection module 120 has no direct physical contact with the target hardware component. Instead, the fault is injected using an external source, such as heavy-ion radiation (an ion passes through the depletion region of the target hardware component and generates current) or electromagnetic interference (the target hardware component is placed in or near an electromagnetic field).

The system monitoring module 230 tracks execution of the fault injection commands and performs data collection, processing, and analysis to assess the performance of the component(s) under test and the target system 120. Activated faults may cause one or more errors to occur in the target component and can lead to component or target system 120 failure, e.g., a service outage. For example, where the target component is a central processing unit (CPU) of the target system 120, the injected faults may cause skipped or repeated CPU instructions, incorrect evaluation of CPU instructions, or corrupt reads from memory devices and can simultaneously impact all stages of a CPU pipeline.

The system monitoring module 230 monitors the target system 120 to detect the creation of an incident related to the one or more injected faults. In one embodiment, the system monitoring module 230 detects incident creation via an application programming interface (API) that facilitates data exchange between the fault injection system 110 and the target system 120. Alternatively, an incident response subsystem at the target system 120 can be configured to automatically notify the fault injection system 110 upon creation of an incident associated with a component under test.

Upon detecting the creation of an incident report for the target component, the system monitoring module 230 instructs the fault injection module 220 to implement countermeasures to automatically roll back the one or more injected faults. In one embodiment, the incident is automatically updated to indicate that the anomaly may have been caused by the injected fault such that the target system operator may investigate and remediate the cause of the anomaly. Depending on the type of fault(s) injected, countermeasures may include removal of added code, reversal of code alterations, reconnecting a data center, powering on a machine, reconnecting a network cable, re-enabling an access key, re-instating a software package from a package repository, and the like.

In one embodiment, one or more rollback countermeasures are defined before a fault is injected (e.g., based on the fault type, fault location, target system, or one or more other types of fault parameters) and tested in a pre-production environment to ensure that the countermeasures correctly and completely roll back a corresponding fault. Each countermeasure may be associated with a validation script (also tested in pre-production), which validates that the fault rollback is performed correctly.

The target component(s) behavior under the adverse conditions associated with the injected fault(s) may be logged and stored in the fault library 250. In addition to the fault injection parameters discussed above, the system monitoring module 230 may collect and analyze data regarding the effect of the fault(s) on the target component behavior and the behavior of other software or hardware components of the target system 120, the impact on external systems or users, the time between fault injection and incident creation at the target system 120. In one example, the injected fault may manifest in the affected system as skipped or repeated CPU instructions, incorrect evaluation of CPU instructions, or corrupt reads from memory devices and can cause the target component to execute unintended or insecure code paths. In another example, where the fault is a simulated expiration of a TLS certificate, the effect of the fault may be a system or website outage and a warning to users attempting to reach that the target system or website is not secure.

Responsive to the fault injection module 220 implementing the rollback mechanisms, the reporting module 240 notifies the target system 120 of the fault injection and, optionally, an assessment of the effected target system components. In one embodiment, the system monitoring module 230 generates a fault injection report based on the collected data regarding performance of the component under test and the target system 120 and sends the report to the reporting module 240 for relay to an operator of the target system 120 (e.g., to a user device 130 of the target system 120 who has provided instructions to conduct the fault injection testing and specified one or more fault injection parameters). The fault injection report may identify, for example, the type of injected fault(s), the target component(s), timestamps associated with fault injection and incident creation, implemented countermeasure(s), and the effects of the injected fault(s) on the target component and other components of the target system 120, including an indication of impacted internal or external users of the target system 120. The fault injection testing and associated report thus allows users of the target system 120 to identify and correct system defects and security vulnerabilities before anomalies occur without the possibility of rollback.

In some embodiments, the same target software or hardware component is tested more than once by injecting the same fault or a different fault, or a different combination of faults. For example, where the target component comprises software, the fault injection system 110 may perform both code modification and insertion in different tests or may perform a first type of runtime injection during a first test and a second type during a second test. In another example, target component code may be modified and code added during a single fault injection test.

The fault library 250 stores data regarding previous testing, including indications of previously tested software and hardware components associated with target systems 120, associated injected faults and countermeasures, performance of the target components and other components of the target systems 120 in response to the testing, time to incident creation and fault rollback, and the like.

### EXAMPLE METHODS

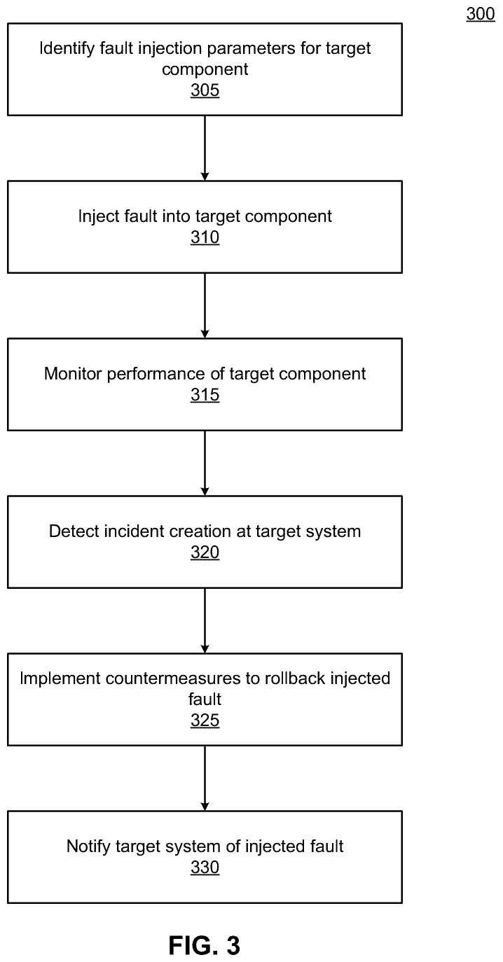

FIG. 3 illustrates an example method 300 for automatic rollback of an injected fault, according to one embodiment. The steps of FIG. 3 are illustrated from the perspective of the fault injection system 110 performing the method 300. However, some or all of the steps may be performed by other entities or components. In addition, some embodiments may perform the steps in parallel, perform the steps in different orders, or perform different steps. Moreover, while the embodiment described herein contemplates injection of a single fault into a single component of a target system 120, in other embodiments, multiple faults are simultaneously injected into a single component or multiple hardware or software target system components.

In the embodiment shown in FIG. 3, the method 300 begins with the fault identification module 210 identifying 305 fault injection parameters for testing a software or hardware component of a target system 110. Fault injection parameters may include, for example, an identification of a target component, a fault type, a fault location, a fault amplitude, a fault activation time or condition, a predicted impact on the behavior of the target component or target system 120, and the like.

In various embodiments, the one or more fault injection parameters based on user input via the user device 130 to the fault injection system 110 or are determined by the fault identification module 210 based, e.g., an identified or suspected vulnerability at the target system 120, previous testing of the target component or related components of the target system 120, previous fault injection testing of the target component or similar components at other target systems 120, and the like.

The fault identification module 210 sends the fault identification parameters to the fault injection module 220, which injects 310 the fault into the predetermined location of the target component based on the parameters. In one example, where the parameters include a fault activation condition, the fault injection module 220 monitors the target system 120 for occurrence of the condition and automatically injects the fault in response to determining that the condition has occurred. Methods of fault injection are based on the type of component under test and may include one or more of the techniques discussed above with respect to FIG. 2.

The fault injection module 220 notifies the system monitoring module 230 upon fault injection to allow the system monitoring module 230 to monitor 315 performance of the target component and target system 120 under test. In one embodiment, the monitoring includes data logging and analysis of the target system's behavior under adverse conditions, including target system 120 failure points, service outages, impacts on one or more related software or hardware components of the target system 120, attempted remediation efforts, and the like.

The system monitoring module 230 detects creation of an incident at the target system 120 and notifies the fault injection module 220, which automatically implements 325 one or more countermeasures to roll back the injected fault. For example, where the fault is powering off of a server or other machine, the countermeasure may be powering on the affected machine. In another example, where the fault is disabling network connectivity, the fault injection module 220 reenables connectivity. In still another example, where the injected fault is modification of source code, the fault injection module 220 reverts the affected code to its original state.

At 330, the reporting module 240 notifies an operator of the target system 120n (e.g., via the user device 130) of the injected fault and, optionally, sends a fault injection report summarizing the fault injection test and collected data, enabling operators of the target system 120 to correct component or system vulnerabilities and mitigate the risk of the fault occurring later without the possibility of rollback.

### Computing System Architecture

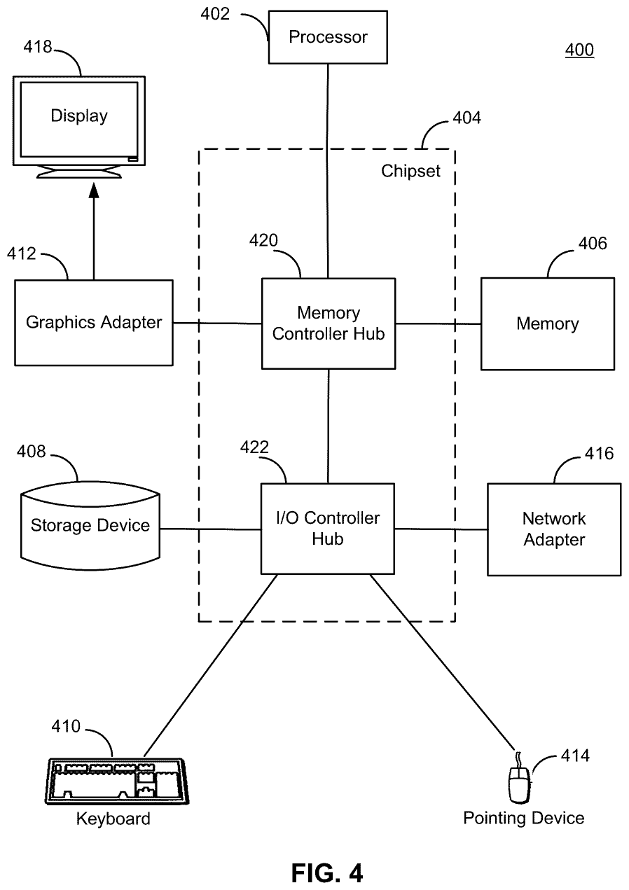

The entities shown in FIG. 1 are implemented using one or more computers. FIG. 4 is an example architecture of a computing device, according to an embodiment. Although FIG. 4 depicts a high-level block diagram illustrating physical components of a computer used as part or all of one or more entities described herein, in accordance with an embodiment, a computer may have additional, fewer, or variations of the components provided in FIG. 4. Although FIG. 4 depicts a computer 400, the figure is intended as functional description of the various features that may be present in computer systems than as a structural schematic of the implementations described herein. In practice, and as recognized by those of ordinary skill in the art, items shown separately could be combined and some items could be separated.

Illustrated in FIG. 4 are at least one processor 402 coupled to a chipset 404. Also coupled to the chipset 404 are a memory 406, a storage device 408, a keyboard 410, a graphics adapter 412, a pointing device 414, and a network adapter 416. A display 418 is coupled to the graphics adapter 412. In one embodiment, the functionality of the chipset 404 is provided by a memory controller hub 420 and an I/O controller hub 422. In another embodiment, the memory 406 is coupled directly to the processor 402 instead of the chipset 404. In some embodiments, the computer 400 includes one or more communication buses for interconnecting these components. The one or more communication buses optionally include circuitry (sometimes called a chipset) that interconnects and controls communications between system components.

The storage device 408 is any non-transitory computer-readable storage medium, such as a hard drive, compact disk read-only memory (CD-ROM), DVD, or a solid-state memory device or other optical storage, magnetic cassettes, magnetic tape, magnetic disk storage or other magnetic storage devices, magnetic disk storage devices, optical disk storage devices, flash memory devices, or other non-volatile solid state storage devices. Such a storage device 408 can also be referred to as persistent memory. The pointing device 414 may be a mouse, track ball, or other type of pointing device, and is used in combination with the keyboard 410 to input data into the computer 400. The graphics adapter 412 displays images and other information on the display 418. The network adapter 416 couples the computer 400 to a local or wide area network.

The memory 406 holds instructions and data used by the processor 402. The memory 406 can be non-persistent memory, examples of which include high-speed random-access memory, such as DRAM, SRAM, DDR RAM, ROM, EEPROM, flash memory.

As is known in the art, a computer 400 can have different and/or other components than those shown in FIG. 4. In addition, the computer 400 can lack certain illustrated components. In one embodiment, a computer 400 acting as a server may lack a keyboard 410, pointing device 414, graphics adapter 412, and/or display 418. Moreover, the storage device 408 can be local and/or remote from the computer 400 (such as embodied within a storage area network (SAN)).

As is known in the art, the computer 400 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 408, loaded into the memory 406, and executed by the processor 402.

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the element or component is present unless it is obvious that it is meant otherwise.

Where values are described as “approximate” or “substantially” (or their derivatives), such values should be construed as accurate +/-10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

While particular embodiments and applications have been illustrated and described, it is to be understood that the described subject matter is not limited to the precise construction and components disclosed. The scope of protection should be limited only by any claims that ultimately issue.

What is claimed is:

1. A computer-implemented method comprising:
determining, by a fault injection system, one or more fault injection parameters for testing one or more target components of a target system;
injecting the one or more faults into the one or more target components of the target system according to the determined parameters;
monitoring behavior of the one or more target components and the target system to assess performance of the components and system under adverse conditions created by the one or more injected faults;
detecting, by the fault injection system, creation of an incident report at the target system; and
implementing one or more countermeasures to automatically roll back the one or more injected faults responsive to detecting incident report creation.

2. The computer-implemented method of claim 1, further comprising:
generating, by the fault injection system, a fault injection report describing performance of the target component and target system under the adverse conditions; and
sending the fault injection report to the target system responsive to roll back of the one or more injected faults.

3. The computer-implemented method of claim 1, wherein the target component is a software component of the target system and wherein the fault injection system injects the one or more faults into the target component via runtime injection techniques.

4. The computer-implemented method of claim 1, wherein the target component is a hardware component of the target system and wherein the fault injection system injects the one or more faults into the target component via pin-level injection or injection without contact.

5. The computer-implemented method of claim 1, wherein the fault injection parameters include one or more of a fault type, a fault location, a fault amplitude, a fault activation time or condition, and a predicted impact on target component or system behavior.

6. The computer-implemented method of claim 1, wherein the one or more countermeasures are defined and tested prior to injection of the one or more faults.

7. The computer-implemented method of claim 1, wherein at least one of the fault injection parameters is specified by an operator of the target system via input to the fault injection system.

8. The computer-implemented method of claim 1, wherein the fault injection system detects creation of an incident by calling an application programming interface (API) associated with the target system.

9. The computer-implemented method of claim 1, wherein an incident is manually created at the target system in response to detection of one or more anomalies in a target system component or subsystem.

10. The computer-implemented method of claim 1, wherein an incident is automatically created at the target system by:
running, on the target system, a probe configured to execute on the target system at a specified interval to collect telemetry data describing operations of the target system;
responsive to telemetry data failing one or more tests, automatically creating the incident.

11. The computer-implemented method of claim 1, wherein the incident is associated with an incident log including one or more of an identification of an anomaly in the target system, an initial classification of the anomaly, an indication of one or more infected components or subsystems, timestamps, network logs, a source of the anomaly, an initial assessment of an impact of the anomaly on the target system, an initial assessment of an impact of the anomaly on internal and external users of the target system, response measures, and an identification of previous incidents associated with the one or more infected components or subsystems.

12. A non-transitory computer-readable storage medium comprising instructions executable by a processor, the instructions executable to perform operations comprising:
determining, by a fault injection system, one or more fault injection parameters for testing one or more target components of a target system;
injecting the one or more faults into the one or more target components of the target system according to the determined parameters;
monitoring behavior of the one or more target components and the target system to assess performance of the components and system under adverse conditions created by the one or more injected faults;
detecting, by the fault injection system, creation of an incident report at the target system; and
implementing one or more countermeasures to automatically roll back the one or more injected faults responsive to detecting incident report creation.

13. The non-transitory computer-readable storage medium of claim 12, wherein the operations further comprise:
generating, by the fault injection system, a fault injection report describing performance of the target component and target system under the adverse conditions; and
sending the fault injection report to the target system responsive to roll back of the one or more injected faults.

14. The non-transitory computer-readable storage medium of claim 12, wherein the target component is a software component of the target system and wherein the fault injection system injects the one or more faults into the target component via runtime injection techniques.

15. The non-transitory computer-readable storage medium of claim 12, wherein the target component is a hardware component of the target system and wherein the fault injection system injects the one or more faults into the target component via pin-level injection or injection without contact.

16. The non-transitory computer-readable storage medium of claim 12, wherein the fault injection system detects creation of an incident by calling an application programming interface (API) associated with the target system.

17. The non-transitory computer-readable storage medium of claim 12, wherein an incident is manually created at the target system in response to detection of one or more anomalies in a target system component or subsystem.

18. The non-transitory computer-readable storage medium of claim 12, wherein an incident is automatically created at the target system by:
running, on the target system, a probe configured to execute on the target system at a specified interval to collect telemetry data describing operations of the target system;
responsive to telemetry data failing one or more tests, automatically creating the incident.

19. The non-transitory computer-readable storage medium of claim 12, wherein the incident is associated with an incident log including one or more of an identification of an anomaly in the target system, an initial classification of the anomaly, an indication of one or more infected components or subsystems, timestamps, network logs, a source of the anomaly, an initial assessment of an impact of the anomaly on the target system, an initial assessment of an impact of the anomaly on internal and external users of the target system, response measures, and an identification of previous incidents associated with the one or more infected components or subsystems.

20. The non-transitory computer-readable storage medium of claim 12, wherein the fault injection parameters include a predicted impact on target component or system behavior.
